(19) United States
(12) Patent Application Publication
(10) Pub. No.: US 2007/0019415 A1
(43) Pub. Date: Jan. 25, 2007

(54) LED floodlight system

(75) Inventors: Kenneth J. Leblanc, Gloucester, MA (US); Luke D. Hagan, Providence, RI (US); Bill Hammond, Seabrook, NH (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: ITT Industries

(21) Appl. No.: 11/409,512

(22) Filed: Apr. 20, 2006

Related U.S. Application Data
(60) Provisional application No. 60/673,978, filed on Apr. 22, 2005.

(51) Int. Cl. F21V 7/00

(52) U.S. Cl. 362/299

(57) ABSTRACT

A new and unique LED-based floodlight is provided having an LED light module and a control module. In operation, the LED light module responses to one or more control signals from the control module, and provides an LED array of light having a broad beam pattern from side-to-side with a selected lamp color, brightness, or some combination thereof; while the control module responds to one or more user inputs from a user, and provides the one or more control signals for operating the LED array module in order to provide the LED array of light having the broad beam pattern from side-to-side with the selected lamp color, brightness, or some combination thereof. The broad beam pattern of the LED array of light effectively has a lumen output of about 200 lumens that is equivalent to a 35 watt halogen floodlight output of the same angle. The selected lamp color may include white, warm white, nav red, nav blue and a “bug” light, as well as other suitable lamp colors, while the selected brightness may include different dimming levels for setting the overall brightness of the LED-based floodlight.

### CROSS-REFERENCE TO RELATED APPLICATIONS

This application claims benefit to provisional patent application Ser. No. 60/673,978, filed Apr. 22, 2005, which is hereby incorporated by reference in its entirety.

### BACKGROUND OF THE INVENTION

1. Field of the Invention

The present invention relates to floodlights for recreational boating and/or recreational vehicles.

2. Description of Related Art

Currently available halogen-based floodlights suffer from a number of disadvantages, including their large size, high amp draw, pre-set beam angle, no brightness adjustment, short bulb life and non-variable color temperature (red for the retention of night vision, for example).

There is a need in the recreational boating and/or vehicle industry or marketplace for a floodlight that addresses many of the aforementioned disadvantages associated with currently available halogen-based floodlights.

### SUMMARY OF THE INVENTION

The present invention provides a new and unique LED-based floodlight having an LED light module and a control module. In operation, the LED light module responses to one or more control signals from the control module, and provides an LED array of light having a broad beam pattern from side-to-side with a selected lamp color, brightness, or some combination thereof; while the control module responds to one or more user inputs from a user, and provides the one or more control signals for operating the LED array module in order to provide the LED array of light having the broad beam pattern from side-to-side with the selected lamp color, brightness, or some combination thereof.

The broad beam pattern of the LED array of light effectively has a lumen output of about 200 lumens that is equivalent to a 35 watt halogen floodlight output of the same angle. The selected lamp color may include white, warm white, nav red, nav blue and a “bug” light, as well as other suitable lamp colors, while the selected brightness may include different dimming levels for setting the overall brightness of the LED-based floodlight.

The LED-based floodlight may include a user keypad controller having at least three buttons, including a color button, a dim button and an on/off button for receiving the one or more user inputs from the user.

In addition, the LED-based floodlight may also include a new and unique shut-down mode memory module that saves settings so that the floodlight may be re-started at a saved setting. The floodlight also includes a volt operation module for providing a 12/24 volt operation for the user.

The LED array may include dual red, green and blue (RGB) LEDs that are wired in parallel so that if one RGB LED fails, the floodlight may be operated with the other RGB LED.

The LED light module may take the form of a micro diffusion filter module arranged in relation to an LED color module for providing a substantially uniform broad beam pattern and brightness and to mask the LED array visually when the floodlight is off. The substantially uniform broad beam pattern may have a beam angle of, for example, about 20°×45°. The micro diffusion filter module may also include a holographic diffuser for homogenizing individual LED light beams and eliminating chromatic aberrations.

In one embodiment, the LED light module may include a plurality of micro diffusion filter modules that are interchangeable by the user for providing a plurality of different broad beam patterns, as desired by the user. In this case, the plurality of different broad beam patterns may include, for example, beam angles of about 20°×45°, about 45°×80°, as well as other suitable beam angles.

In a preferred embodiment of the present invention, the micro diffusion filter module is arranged in a cover of the floodlight. The cover may be pivotally arranged on a housing of the floodlight for opening and closing to change the micro diffusion filter module, when desired. The cover and the housing may have a fully sealed waterproof seal.

The LED light module may also include a plurality of interchangeable LED color cards for providing a plurality of different lamp colors, including white, warm white, nav red, nav blue and a “bug” light, as well as other suitable lamp colors.

The floodlight also includes a dual fresnel lens for collecting and collimating the LED array of light into a desirable light beam, that is also arranged and retained in the cover of the floodlight.

The LED light module may also include one or more microlens for focusing divergent light from the LED array.

In an alternative embodiment, the LED-based floodlight may include a movable holder having a dual fresnel lens for collecting and collimating the LED array of light into a desirable light beam and a holographic diffuser for homogenizing individual LED light beams and eliminating chromatic aberrations, both arranged therein. In this embodiment, the movable holder responds to the one or more control signals, for moving from one position to another position to change the broad beam pattern, for example, for providing a narrow beam pattern in one position and a wide beam pattern in the other position, or vice versa.

The LED-based floodlight according to the present invention addresses the aforementioned concerns and disadvantages of the currently available halogen-based floodlights by providing equivalent light from a much smaller LED light array which, by design, is more efficient and draws less amperage. The unique innovative use of RGB (red, green, blue) LED arrays coupled with microlens primary optics, and a movable holographic diffusion layer coupled to dual fresnel secondary optics, provides for a user-adjustable beam angle and light color selection. The LED array's rated life of 10,000 hours far exceeds the 500 hours rated life for halogen bulbs.

The LED-based floodlight according to the present invention is an important contribution to the state of the art for recreational boating and/or vehicles.

### BRIEF DESCRIPTION OF THE DRAWING

FIG. 1 is a block diagram of a floodlight according to the present invention.

FIG. 2 is a block diagram of a keypad controller according to the present invention.

FIG. 3 includes diagrams of one embodiment of a bracket mounted floodlight according to the present invention, wherein FIG. 3a shows front and back diagrams of the floodlight; wherein FIG. 3b shows the floodlight with the cover open; and wherein FIG. 3c shows a plurality of micro diffusion filter modules that are interchangeable for providing a plurality of different broad beam patterns, as desired by a user.

FIG. 4 includes diagrams of another embodiment of a floodlight having a movable holder according to the present invention, wherein FIG. 4a shows the floodlight having the movable holder in one position for providing a narrow beam angle; and wherein FIG. 4b shows the floodlight having the movable holder in another position for providing a wide beam.

FIG. 5 shows an exploded view of the main floodlight components according to the present invention.

FIG. 6 shows a diagram of one embodiment of an LED bracket mounted floodlight according to the present invention.

FIG. 7 shows a diagram of another alternative embodiment an LED floodlight according to the present invention.

### DETAILED DESCRIPTION OF THE INVENTION

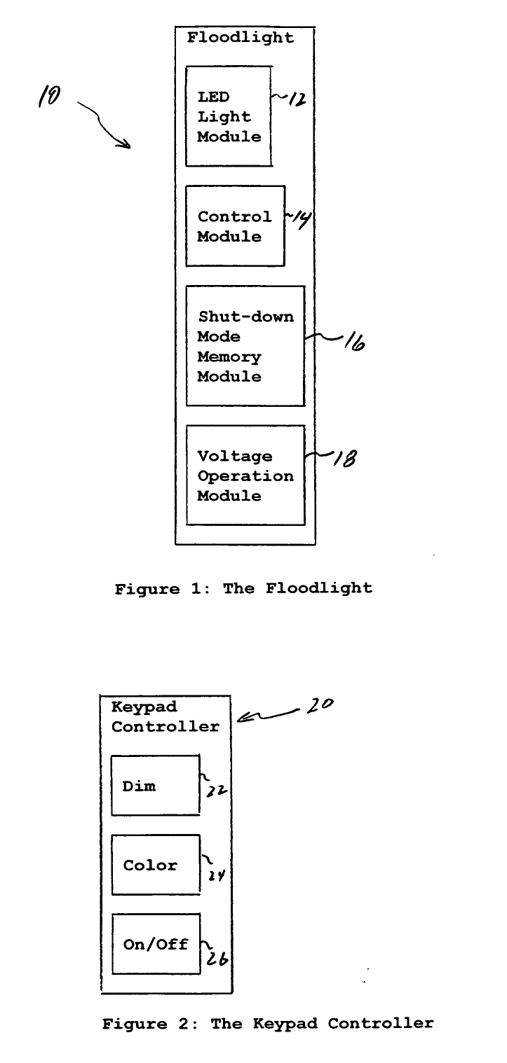

FIG. 1 shows the new and unique LED-based floodlight generally indicated as 10 having an LED light module 12 and a control module 14. In operation, the LED light module 12 responses to one or more control signals from the control module 14, and provides an LED array of light having a broad beam pattern from side-to-side with a selected lamp color, brightness, or some combination thereof; while the control module 14 responds to one or more user inputs from a user, and provides the one or more control signals for operating the LED array module 12 in order to provide the LED array of light having the broad beam pattern from side-to-side with the selected lamp color, brightness, or some combination thereof.

The selected lamp color may include white, warm white, nav red, nav blue and a “bug” light, as well as other suitable lamp colors. The scope of the invention is not intended to be limited to any particular lamp color either now known or later developed in the future.

The selected brightness may include different dimming levels, such as high, medium and low, for setting the overall brightness of the floodlight based on a particular need of the user.

In operation, the broad beam pattern of the LED array of light effectively has a lumen output of about 200 lumens that is equivalent to a 35 watt halogen floodlight output of the same angle. The LED-based floodlight according to the present invention also has a substantially longer minimum bulb life, before any bulb change would be needed.

The LED-based floodlight 10 according to the present invention may also include a new and unique shut-down mode memory module 16 that saves settings so that the floodlight may be re-started by the-user at a saved setting, so the user does not have to adjust the settings of the floodlight each time it is turned on and off.

The LED-based floodlight according to the present invention may also include a volt operation module 18 for providing a 12/24 volt operation, that enables the operation of the floodlight at different voltage levels consistent with that shown and described herein. Although the present invention is described with 12/24 volt operation, embodiments are envisioned using other voltages; and the scope of the invention is not intended to be limited to any particular number of different voltages or voltage values of operation either now known or later developed in the future.

Overall, the LED-based floodlight according to the present invention that can be bracket, flush or surface mounted, consistent with that shown and described herein. The floodlight features beam angle adjustment, electronically controlled color temperature selection and brightness adjustment (dimmable).

### The Keypad Controller

FIG. 2 shows a user keypad controller generally indicated as 20 having at least three buttons, including a color button 22, a dim button 24 and an on/off button 26 for receiving the one or more user inputs from the user. The keypad controller 20 responds to the user input, and provides corresponding keypad controller signals to the control module 14 in FIG. 1. The keypad controller 20 may be a completely separate module, or form part of the control module 14 in FIG. 1. Keypad controller for accepting user inputs such as that shown in FIG. 2 are known in the art and the scope of the invention is not intended to be limited to any particular type or kind thereof either now known or later developed in the future.

The keypad controller 20 may be surface mounted, if possible, with dimensions not to exceed 3″H×2″W×0.5″D deep. By way of example depending on the particular application, if the controller 20 requires through-hole mounting on a boat or other recreational vehicle, the cut-out may be the standard 1.45″×0.83″ panel rocker switch size, including an 8-foot cable to be included with a weatherproof connector at the light end and a water resistant connector at the controller end.

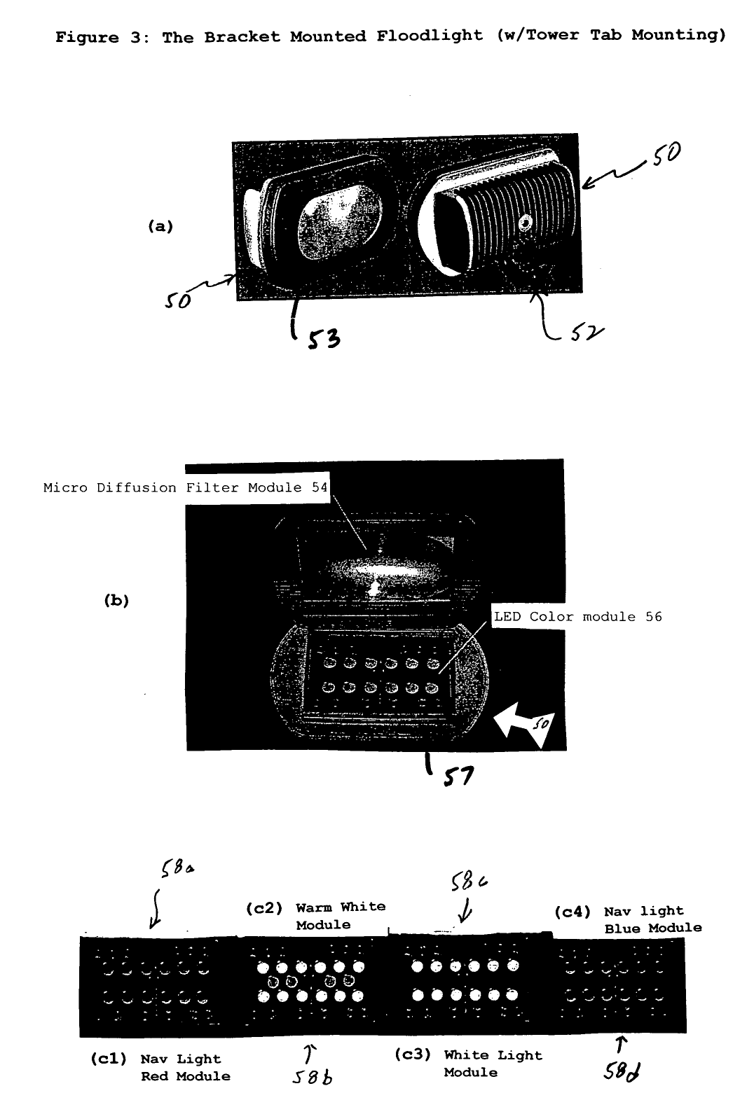

### FIG. 3: The Bracket Mounted Floodlight

FIG. 3 shows one embodiment of an LED-based floodlight according to the present invention in the form of a bracket mounted floodlight generally indicated as 50 with suitable tower tab mounting generally indicated as 52, as best shown in FIG. 3a.

In FIG. 3b, the bracket mounted floodlight 50 has a micro diffusion filter module 54 and an LED color card or module 56, which together form part of the LED light module 12 in FIG. 1.

As shown by way of example, the micro diffusion filter module 54 is arranged in a cover 53 (shown in the open position) of the floodlight 50 in relation to the LED color card or module 56 for providing a substantially uniform broad beam pattern and brightness and to mask the LED array visually when the floodlight is off. Micro diffusion filter module such as 54 are known in the art and the scope of the invention is not intended to be limited to any particular type or kind either now known or later developed in the future. The substantially uniform broad beam pattern may have a beam angle of, for example, about 20°×45°, although the scope of the invention is intended to include other broad beam patterns having other beam angles. The floodlight according to the present invention may also include, and be sold with, a plurality of micro diffusion filter modules such as 54 that are interchangeable by the user for providing a plurality of different broad beam patterns, as desired by the user depending on a particular application. In this embodiment, the micro diffusion filter modules 54 may be detachably arranged and frictionally engaged in the cover 53 for changing by the user. Many different ways detachably arranging and frictionally engaging one device in relation to another device are known in the art, and the scope of the invention is not intended to be limited to any particular type or kind thereof either now known or later developed in the future. In this case, the plurality of different broad beam patterns provided by the plurality of micro diffusion filter modules such as 54 may include, for example, beam angles of about 20°×45°, or about 45°×80°, as well as other suitable beam angles, although the scope of the invention is intended to include other broad beam patterns having other beam angles.

The micro diffusion filter module 54 may also include a diffuser, such as holographic diffuser, for homogenizing individual LED light beams and eliminating chromatic aberrations. Diffuser such as 54 are known in the art, and the scope of the invention is not intended to be limited to any particular type or kind thereof either now known or later developed in the future.

The LED color module 56 may take the form of an LED color card for providing the LED array of light in a particular lamp color, for example, in response to the one or more control signals from the control module 14 in FIG. 1. LED color cards or modules such as 56 are known in the art and the scope of the invention is not intended to be limited to any particular type or kind thereof either now known or later developed in the future, including an LED lamp card or module that responds to a change in current, for providing a different lamp color.

The LED-based floodlight according to the present invention may also include, and be sold with, a plurality of different LED color cards or modules such as 58a, 58b, 58c, 58d as best shown in FIGS. c1, c2, c3, c4, that are interchangeable by a user for providing a plurality of different lamp colors, including white, warm white, nav red, nav blue and a “bug” light, as well as other suitable lamp colors. The interchangeable LED color cards or modules 58a, 58b, 58c, 58d may be changed by a user to provide a particular lamp color based on a particular needs or application of the user. In this case, the LED color card 56 may be detachably arranged and frictionally engaged in the housing 57 of the floodlight 50 for changing by the user. Consistent with that discussed above, many different ways detachably arranging and frictionally engaging one device in relation to another device are known in the art, and the scope of the invention is not intended to be limited to any particular type or kind thereof either now known or later developed in the future.

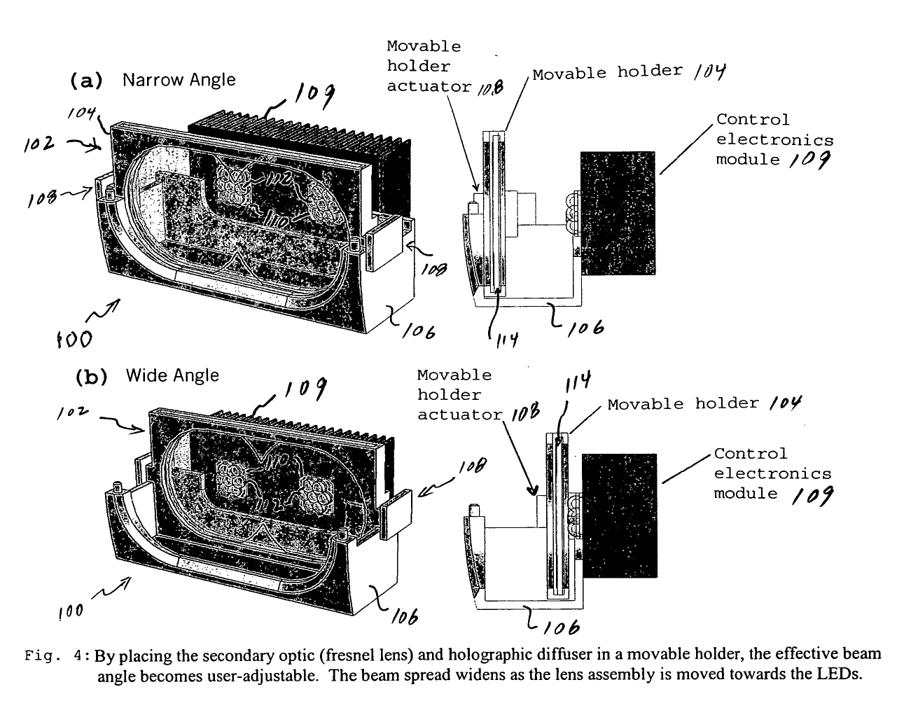

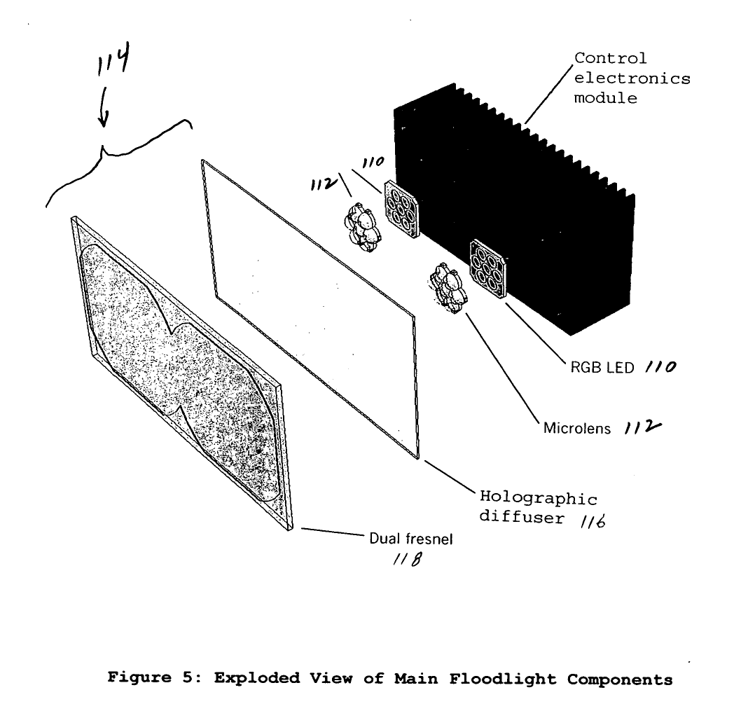

### FIGS. 4-5: The Movable Holder Embodiment

FIG. 4 shows an LED-based floodlight optical system generally indicated as 100 having a movable holder assembly generally indicated as 102 according to the present invention. The movable holder assembly 102 includes a movable holder 104, a movable holder housing 106 and a movable holder actuator generally indicated as 108. The LED floodlight optical system 100 includes a control electronics module 109 for providing one or more control signals to the movable holder actuator 108 for moving the movable holder 104 according to the present invention.

The LED floodlight optical system includes two RGB (Red, Green, Blue) LEDs 110 that are controlled by the module 109. Similar to that discussed above, the color of the floodlight is user-adjustable. For example, the electronic control circuit or module 109 may vary the current to each of the red, green, and blue LEDs 110 in the arrays to achieve lamp colors such as yellow-white, blue-white, red and green. The control circuit (aka electronics module) 109 may also provide brightness control (dimmable) consistent with that discussed above.

As shown, the optical system 100 consists of the LED arrays 110, a microlens primary optic 112 and a dual fresnel secondary optic generally indicated as 114. In operation, the microlenses 112 focus divergent light from the LED array 110, directing it into the remaining optical system. The holographic diffuser 116 serves to homogenize the individual beams from the microlenses 112 and eliminate chromatic aberrations with very little backscatter and transmission losses. A dual fresnel lens 118 array collects and collimates the LED light into a desirable beam angle. The LED arrays 110 may also be positioned horizontally off-axis in relation to the fresnel lenses 118 such that the resulting output beam is elliptical in shape.

FIGS. 4(a) and (b) show the secondary optics 114 that include the fresnel lens 118 and the holographic diffuser 116 placed in the movable holder 104 so that the effective beam angle becomes user adjustable. FIG. 4(a) shows the arrangement when positioned for a narrow angle, while FIG. 4(b) shows the arrangement when positioned for a wide angle. In operation, the beam spread widens as the lens assembly 114 is moved towards the LEDs 110, for example, when moving from the first lens assembly position shown in FIG. 4(a) to the second lens assembly position shown in FIG. 4(b). The movable holder actuator 108 receives the control signal from the control electronic module 109 for moving the holder 104 from the first lens assembly position to the second lens assembly position, and vice versa, as well as to move the holder 104 to and from one or more other lens assembly positions therebetween. The scope of the invention is not intended to be limited to the number of lens assembly positions shown and described herein.

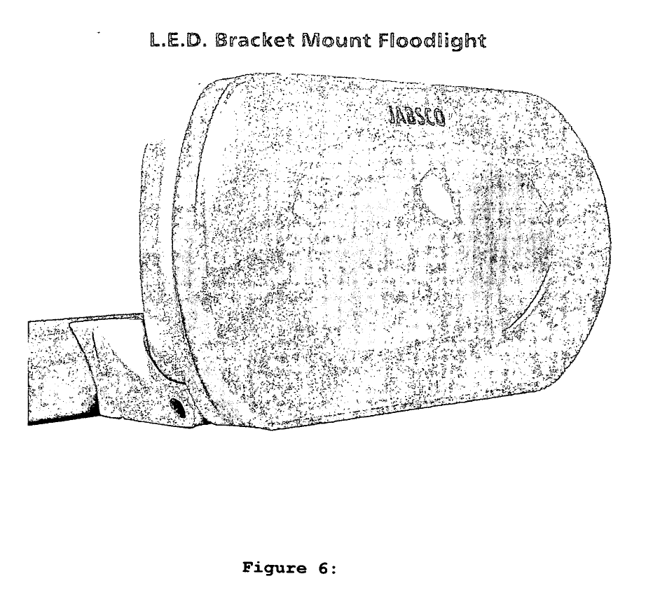

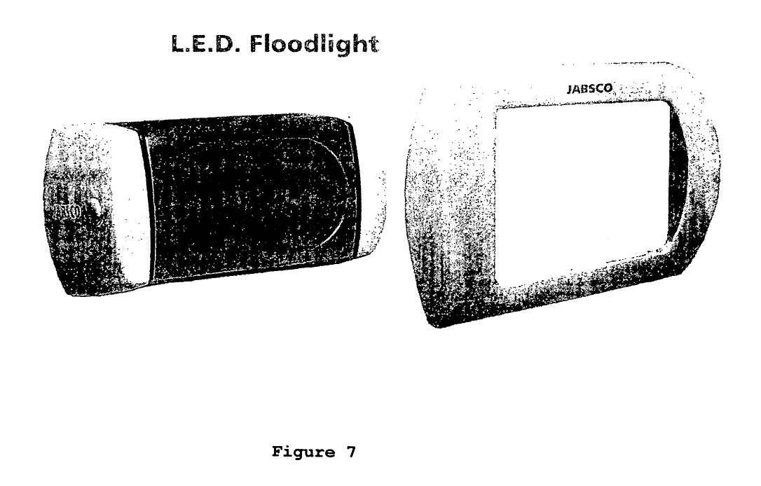

### FIGS. 6-7

FIG. 6 shows an LED bracket mounted floodlight according to the present invention, while FIG. 7 shows an LED floodlight according to the present invention.

Other features of LED-based floodlights according to the present invention may include the following:
Minimum bulb life, 5,000 hours;
Maximum amp draw (sustained) <(1) amp;
Lamp tilts down 90° from vertical;
316 stainless steel mounting bracket and stainless steel Allen locking screw, including
   Bracket footprint not to exceed 1½″×1½″ with u-shaped mounting hole to accommodate bolt, and
   Installation hardware to include 316 stainless steel hex bolt, hex nut and lock washer;
A housing to be made from white Luran®, Geloy® or a comparable non-yellowing ASA thermoplastic;
The ability to withstand 5-year U.V. exposure equivalent without yellowing or cracking of housing or lens system;
The ability to withstand a 600 hour salt spray corrosion test using a 5% NaCI solution without permanent discoloration, corrosion or rusting of metal parts;
The ability to withstand immersion in saltwater (while turned “on”) to a depth of (1) foot for one hour without failure;
An external housing (including heat sink) and lens temperatures that will not exceed b 135° F. after one hour 80° ambient temperature soak with light “on”;
The LED-based floodlight can pass a standard vibration test without damage or movement of the head relative to the bracket. The bracket is to be mounted on the horizontal vibration table with the head locked with the beam axis parallel to the vibration table mounting surface, including 1G input vibration using a sine sweep from 10 to 2,000 Hz for 8-hours with light “on”;
The floodlight can pass a standard shock test without physical damage to the housing, bracket and optical parts. Optical misalignment and movement of the head relative to the bracket may not occur. The light is to be tested “on” with the bracket to a horizontal surface and the beam axis parallel to the mounting surface, including 500 vertical shock impacts with 15G peak acceleration in the vertical direction;
The product design may be clamshell packaged with a 4-color insert card, instructions and hardware. The clamshell size not to exceed 7″ wide×8″ high. Clamshells to be 6-up packed in white carton;
A surface mount bracket and rail adapter plate to be provided. Adapter plate must allow attachment of the light to rails and aluminum tubing with outside diameter (OD) sizes of 1″, 1¼″ and 1½″. Bracket must be reversible relative to the light head to accommodate hardtop installations which require download rotational adjustment of the head; and
A minimum of 45° downward rotation is preferred. For rail and tower (aluminum tubing) installations, bracket/adapter must allow a minimum of 45° backward rotation (90° preferred).

### The Control Module 14

The basic functionality of the control module 14 in FIG. 1 according to the present invention may be implemented using hardware, software, firmware, or a combination thereof, although the scope of the invention is not intended to be limited to any particular embodiment thereof. In a typical software implementation, the control module 14 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the control module 14 being used as stand alone modules, as shown, or in the combination with other circuitry for implementing another module.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed:

1. A floodlight comprising:
an LED light module, responsive to one or more control signals, for providing an LED array of light having a broad beam pattern from side-to-side with a selected lamp color, brightness, or some combination thereof; and
a control module, responsive to one or more user inputs, for providing the one or more control signals for operating the LED array module in order to provide the LED array of light having the broad beam pattern from side-to-side with the selected lamp color, brightness, or some combination thereof.

2. A floodlight according to claim 1, wherein the selected lamp color includes white, warm white, nav red, nav blue and a “bug” light.

3. A floodlight according to claim 1, wherein the selected brightness includes different dimming levels.

4. A floodlight according to claim 1, wherein the floodlight includes a shut-down mode memory module that saves settings so the floodlight may be re-started at a saved setting.

5. A floodlight according to claim 1, wherein the floodlight includes a volt operation module for providing a 12/24 volt operation.

6. A floodlight according to claim 1, wherein the LED array includes dual red, green and blue (RGB) LEDS that are wired in parallel so that if one RGB LED fails, the floodlight may be operated with the other RGB LED.

7. A floodlight according to claim 1, wherein the control module includes a user keypad controller having at least three buttons, including a color button, a dim button and an on/off button for receiving the one or more user inputs.

8. A floodlight according to claim 1, wherein the LED light module includes a micro diffusion filter module arranged in relation to an LED light module for providing a substantially uniform broad beam pattern and brightness and to mask the LED array visually when the floodlight is off.

9. A floodlight according to claim 8, wherein the substantially uniform broad beam pattern has a beam angle of about 20°×45°.

10. A floodlight according to claim 8, wherein the micro diffusion filter module includes a holographic diffuser for homogenizing individual LED light beams and eliminating chromatic aberrations.

11. A floodlight according to claim 1, wherein the LED light module includes a plurality of micro diffusion filter modules that are interchangeable for providing a plurality of different broad beam patterns.

12. A floodlight according to claim 11, wherein the plurality of different broad beam patterns include beam angles of about 20°×45° or about 45°×80°.

13. A floodlight according to claim 8, wherein the floodlight includes a cover for retaining the micro diffusion filter module.

14. A floodlight according to claim 13, wherein the cover is pivotally arranged on a housing of the floodlight.

15. A floodlight according to claim 14, wherein the cover and the housing have a fully sealed waterproof seal.

16. A floodlight according to claim 1, wherein the LED light module includes a plurality of interchangeable LED color cards for providing a plurality of different lamp colors.

17. A floodlight according to claim 16, wherein the plurality of different lamp colors include white, warm white, nav red, nav blue and a “bug” light.

18. A floodlight according to claim 1, wherein the broad beam pattern of the LED array of light has a lumen output of about 200 lumens that is equivalent to a 35 watt halogen floodlight output of the same angle.

19. A floodlight according to claim 1, wherein the LED light module includes a dual fresnel lens for collecting and collimating the LED array of light into a desirable light beam.

20. A floodlight according to claim 19, wherein the floodlight includes a cover for retaining the dual fresnel lens.

21. A floodlight according to claim 1, wherein the LED light module includes microlens for focusing divergent light from the LED array.

22. A floodlight according to claim 1, wherein the floodlight includes a movable holder having a dual fresnel lens for collecting and collimating the LED array of light into a desirable light beam; and a holographic diffuser for homogenizing individual LED light beams and eliminating chromatic aberrations.

23. A floodlight according to claim 22, wherein the movable holder responds to the one or more control signals, for moving from one position to another to change the broad beam pattern, including from a narrow beam pattern to a wide beam pattern, or vice versa.

24. A floodlight according to claim 1, wherein the floodlight includes an optical focusing element having a primary optics arrangement for focusing divergent light from the LED array.

25. A floodlight according to claim 24, wherein the primary optics arrangement includes a microlens.

26. A floodlight according to claim 24, wherein the optical focusing element includes a secondary optics arrangement that moves in response to a control signal, for providing the LED array of light having a selected beamwidth, including a wide beam width or a narrow beam width.

27. A floodlight according to claim 26, wherein the secondary optics arrangement includes a holographic diffuser for homogenizing individual LED light beams and eliminating chromatic aberrations.

28. A floodlight according to claim 26, wherein the secondary optics arrangement includes a dual fresnel lens for collecting and collimating the LED array of light into a desirable light beam.

29. A floodlight according to claim 26, wherein the secondary optics arrangement includes a dual fresnel lens for collecting and collimating the LED array of light into a desirable light beam; and a holographic diffuser for homogenizing individual LED light beams and eliminating chromatic aberrations.

30. A floodlight according to claim 26, wherein the optical focusing element also includes a movable holder having the secondary optics arrangement arranged therein to move in response to the control signal.

31. A floodlight according to claim 30, wherein the secondary optics arrangement includes a dual fresnel lens for collecting and collimating the LED array of light into a desirable light beam; and a holographic diffuser for homogenizing individual LED light beams and eliminating chromatic aberrations.

32. A floodlight according to claim 24, wherein the optical focusing element includes a dual fresnel lens for collecting and collimating the LED array of light into a desirable light beam; and the LED array is positioned horizontally off-axis in relation to the dual fresnel lens so that the resulting output beam is elliptical in shape.

33. A floodlight having an optical arrangement for providing light on a recreational boat or vehicle, the optical arrangement comprising:
an LED array, responsive to a first control signal, for providing an LED array of light having a selected lamp color and/or brightness;
a microlens coupled to the LED array for focusing divergent light from the LED array;
a holographic diffuser for homogenizing individual light beams from the microlens and eliminating chromatic aberrations;
a dual fresnel lens for collecting and collimating the LED light into a desirable light beam;
a movable holder for holding the holographic diffuser and the dual fresnel lens and moving the same in relation to the LED array in response to a second control signal, for providing the LED array of light having a selected beamwidth, including a narrow or wide beamwidth; and
a control circuit, responsive to one or more user inputs, for providing one or more control signals for providing the LED array of light having the selected beamwidth, lamp color, brightness, or some combination thereof.

34. A floodlight according to claim 33, wherein the first control signal varies the current to each red, green and blue LED in the LED array for providing different lamp colors and brightnesses.

35. A floodlight according to claim 33, wherein the LED array is positioned horizontally off-axis in relation to the dual fresnel lens so that the resulting output beam is elliptical in shape.
